(19) United States
(12) Patent Application Publication
(10) Pub. No.: US 2009/0024458 A1
(43) Pub. Date: Jan. 22, 2009

(54) Position-based Charging

(76) Inventor: Charles Graham Palmer, Baslow (GB)

Correspondence Address: RICHARD M. GOLDBERG, 25 EAST SALEM STREET, SUITE 419, HACKENSACK, NJ, 07601, US

(21) Appl. No.: 12/173,261

(22) Filed: Jul. 15, 2008

(30) Foreign Application Priority Data
Jul. 16, 2007 (GB) 07 13 761.5
Nov. 30, 2007 (GB) 07 23 473.5

(51) Int. Cl. G06Q 20/00

(52) U.S. Cl. 705/13

(57) ABSTRACT

A method of position-based charging comprises the steps of identifying journey details, including a plurality of position data each representing a location of a position-sensing device during a journey. A cost is determined for the journey and the cost and an identification of the position-sensing device are forwarded from the position-sensing device to a payment processing service.

### BACKGROUND OF THE INVENTION

1. Field of the Invention

The present invention relates to a method of position-based charging and apparatus for use in the same.

2. Description of the Related Art

Systems are known for charging users of public roads and public transport for the use they make of them. For example, prepayment cards can be used at swipe points for buses and underground trains and at toll booths on motorways. Further, systems are proposed for charging motorists variable amounts of road tax or vehicle insurance premiums depending upon the distance driven, location and time of day. However, these systems are flawed in that it is possible for a third party such as a hacker or government agency to interrogate a database and track a user's movements. This raises serious concerns for user privacy and civil liberties.

### BRIEF SUMMARY OF THE INVENTION

According to an aspect of the present invention, there is provided a method of position-based charging, comprising the steps of identifying journey details including a plurality of position data, each representing a location of a position-sensing device during a journey, determining a cost for the journey, and forwarding the cost and an identification of the position-sensing device from the position-sensing device to a payment processing service.

### BRIEF DESCRIPTION OF THE SEVERAL VIEWS OF THE DRAWINGS

FIG. 1 shows an environment in which the invention may be embodied;

FIG. 2 illustrates communication between an On-Board Unit, the Location Processing Service and the Payment Processing Service all shown in FIG. 1;

FIG. 3 is a diagram of the On-Board Unit shown in FIG. 2;

FIG. 4 shows the contents of the memory of the processor shown in FIG. 3;

FIG. 5 shows the contents of the memory of the cryptographic engine shown in FIG. 3;

FIG. 6 illustrates the database held by the Location Processing Service shown in FIG. 2;

FIG. 7 details steps carried out by the on-board unit shown in FIG. 3 to obtain a journey cost;

FIG. 8 illustrates processes carried out by the Location Processing Service shown in FIG. 2;

FIG. 9 details the cost calculation process shown in FIG. 8;

FIG. 10 illustrates the database held by the Payment Processing Service shown in FIG. 2;

FIG. 11 details steps carried out by the on-board unit shown in FIG. 3 to provide journey costs to the Payment Processing Service;

FIG. 12 illustrates processes carried out by the Payment Processing Service shown in FIG. 2;

FIG. 13 details the charging process shown in FIG. 12;

FIG. 14 illustrates two embodiments of a compliance check;

FIG. 15 details steps carried out during FIG. 11 to carry out a compliance check;

FIG. 16 details the journey confirmation process shown in FIG. 8;

FIG. 17 details a process carried out by a computer shown in FIG. 1 to obtain an itemised bill;

FIG. 18 details the journey details provision process shown in FIG. 8;

FIG. 19 illustrates a further on-board unit shown in FIG. 1; and

FIG. 20 is a diagram of the on-board unit illustrated in FIG. 19.

### DESCRIPTION OF THE BEST MODE FOR CARRYING OUT THE INVENTION

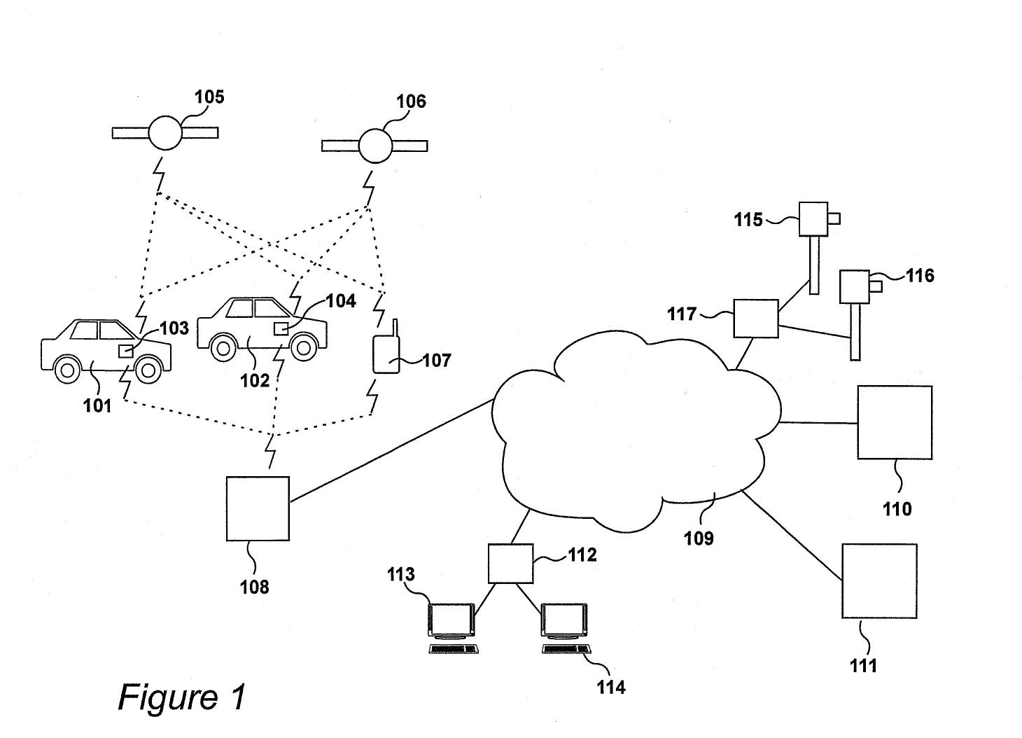

FIG. 1

FIG. 1 illustrates an environment suitable for embodying the invention. Road-using vehicles, such as cars 101 and 102, are each equipped with an on-board unit (OBU), such as on-board unit 103 in car 101 and on-board unit 104 in car 102. The OBUs communicate with global navigation satellite system satellites such as GPS satellites 105 and 106 which enable them to identify their location at any time. Mobile telephone 107 is also GPS-enabled and communicates with satellites 105 and 106 to identify its position at any time. On-board units 103 and 104 and mobile telephone 107 also communicate over a mobile telephone network such as GSM network 108.

GSM network 108 is connected to the Internet 109. Also connected to Internet 109 are Location Processing Service (LPS) 110 and Payment Processing Service (PPS) 111. Preferably the LPS and PPS are services running on separate servers, although they could run on the same server. Internet Service Provider (ISP) 112 is connected to Internet 109 and provides Internet access for computing systems such as personal computers 113 and 114. Road-side cameras 115 and 116 are also connected to Internet 109 via compliance system 117.

Thus on-board units 103 and 104 and mobile telephone phone 107 are examples of position-sensing devices that are able to identify their location and time at a number of points during a journey. In this embodiment this is done using the GPS system but could be done in other ways, for example by monitoring of roadside beacons that constantly transmit radio signals. These devices can communicate with the LPS and PPS, in this example via GSM network 108 and the Internet 109, although any other communication method could be used.

The user of car 101 or 102 or mobile telephone 107 can access the details held on him on LPS 110 and PPS 111 using his personal computer 113 or 114 via ISP 112 and the Internet 109.

A roadside compliance system comprising challenge points such as cameras 115 and 116 can be used to monitor vehicles and ensure that the system is working properly.

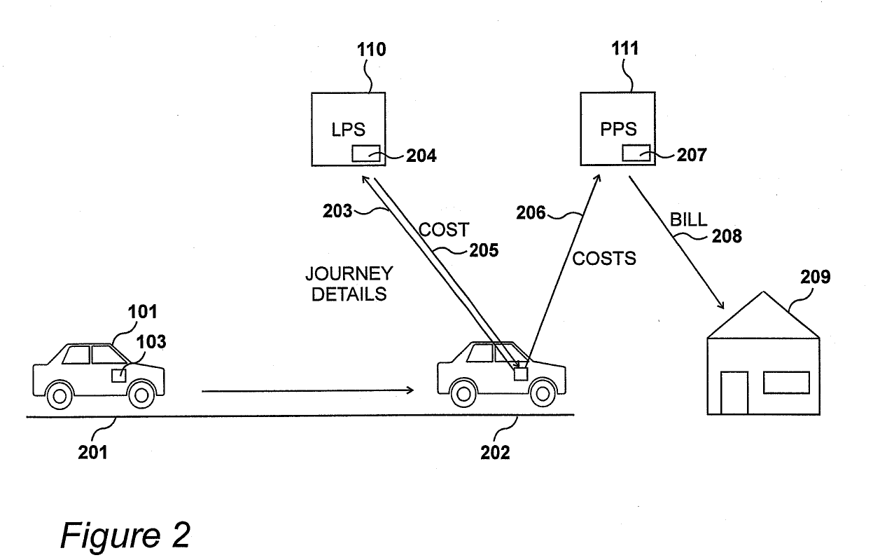

FIG. 2

The location-based charging system is shown in more detail in FIG. 2. Car 101 is driven from position 201 to position 202. OBU 103 notes a time and location for many points between positions 201 and 202 and transmits these journey details 203 anonymously to LPS 110. LPS 110 calculates a cost for the journey, stores the details in a database 204 and returns a cost 205 to OBU 103. This cost need not be obtained as soon as the journey is concluded. In fact, for the sake of privacy it is preferable that a journey be broken down into a number of sub-journeys and that costs for each of these sub-journeys be obtained during separate, non-chronological communications between OBU 103 and LPS 110.

OBU 103 accumulates a plurality of costs 205 and at a convenient time, for example at a particular time of day or when the costs have accumulated beyond a certain level, OBU 103 sends these costs 206 and an identification of itself to PPS 111. PPS 111 then interrogates a database 207 to identify user details associated with OBU 103, converts the costs 206 into a charge 208 and applies this to a user account. Periodically a bill summarising a plurality of charges may be sent to the user 209, for example by post or by email.

The system may be used for many different purposes. The cost 205 is a function of certain attributes of the journey such as distance, location and time and is expressed in a form of units, while the charge 208 is a conversion of the number of units into a monetary or other charge, which may be dependent on particular user details.

Thus, for example, the system could be a usage-based road tax system. The cost of a journey may be a number of units dependent on the distance traveled, and possibly higher for travel on certain roads or at certain times of day, which can then be converted into a charge for vehicle excise duty dependent upon such attributes as engine size.

Alternatively, if the system were for use in vehicle insurance, the cost might be simply a sum of miles. If at the end of the year the total cost, or number of miles, exceeded a set figure, the user might be charged an extra premium, with no charge being made if the cost were below this level.

Alternatively, a user's monthly insurance premium might be entirely dependent on the mileage done over the previous month. Thus the conversion from cost to charge may be linear or the result of a more complex formula. The cost might also additionally take into account the time of travel, class of road used, whether the speed limit was exceeded, whether excessive acceleration or braking was detected, and so on.

Such systems as these would provide a method of charging vehicle users for their actual road use, but their privacy would be ensured. Database 204 on LPS 110 simply identifies a number of journeys and their associated costs. The LPS does not know by whom those journeys were made, since the communication of journey details 203 and costs 205 is done anonymously. Database 207 on PPS 111 knows the identity of a user and a cost that has been accumulated by a particular OBU, but has no way of knowing on what roads or at what time those costs were accumulated. Thus, even if LPS 110 and PPS 111 were to be hacked or their databases fraudulently accessed, any third party would not be able to recreate any user's movements. Thus the system described herein ensures the privacy of the user, which in turn increases the likelihood that the system would be trusted and used.

The privacy of the user is important not only in ensuring that no third party can track their movements but also in ensuring that particular types of sensitive data are not collected. Thus, for example, in a vehicle insurance system the cost of a journey could be an indication of whether the vehicle exceeded the speed limit between the start and end of a journey. Upon an accumulation of these costs over a certain limit, a charge could be applied of an extra insurance premium. Thus an insurance company could charge extra to users who consistently exceed the speed limit, without holding any data on specific transgressions which they might be forced to reveal to the authorities.

Alternatively, in a system owned by a commercial distribution centre, the cost could be the amount of time that an OBU on a truck spent moving, and if the sum of time in one particular day exceeded a particular limit then a charge could be applied which was not a monetary charge but a flagging up to a supervisor that a particular truck driver has been driving for too long. This would enable the company to monitor the health and safety of their drivers without invading their privacy by knowing where they are at all times.

Further implementations could be a charge for driving in certain lanes on multi-lane roads, car park usage, checking that a car was not parked in a residential-only parking area, or for tracing stolen vehicles.

Further, the invention is not limited to the use of OBUs. Any position sensing device, such as GPS enabled mobile telephone 107, could be used. For example, the system could provide payment for public transport services using mobile telephones, in preference to the system in use on many networks where a user shows a swipe card at entry and exit points, allowing his every movement to be logged in a database.

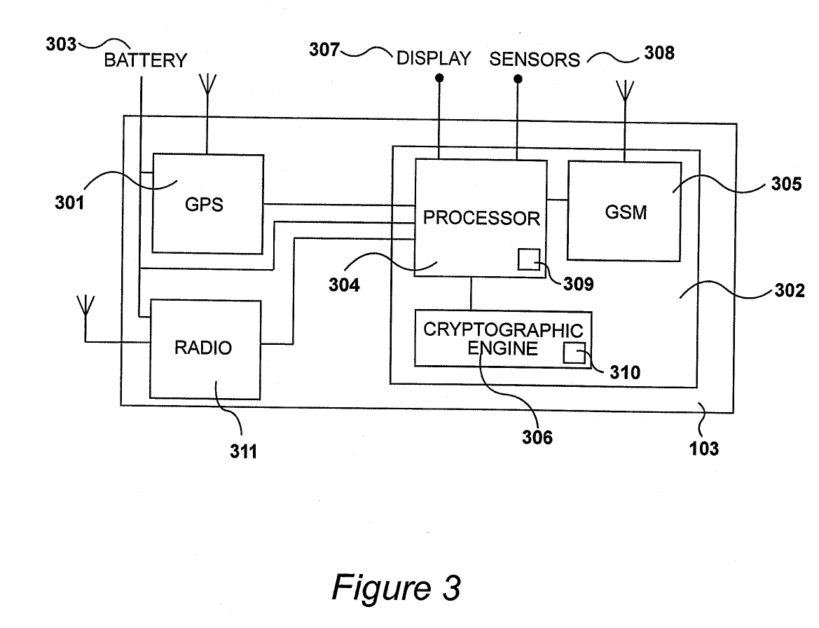

FIG. 3

FIG. 3 details on-board unit 103. In this embodiment the unit is a “black box” attached to car 101. It comprises a GPS receiver 301 connected to a GSM modem 302. Both are powered by the car battery 303. GSM modem 302 comprises a processor 304, a GSM radio module 305 and a cryptographic engine 306 that encrypts and decrypts communication between OBU 103 and LPS 110 or PPS 111. Processor 304 may output information to a display 307 indicating the status of the OBU, and accept input from sensors 308 such as the speedometer, the odometer, an altimeter, a compass, an accelerometer, a thermometer, a barometer, a microphone listening to engine noise, light sensors, and receivers configured to receive random numbers or time stamps broadcast by radio transmitters such as mobile telephone base stations using the broadcast SMS service, short range roadside beacons, or RDS data broadcast by FM radio stations. While none of these sensors is necessary for the functioning of the OBU, data provided by any or all of them could be used to corroborate satellite navigation data and make it harder for this data to be spoofed.

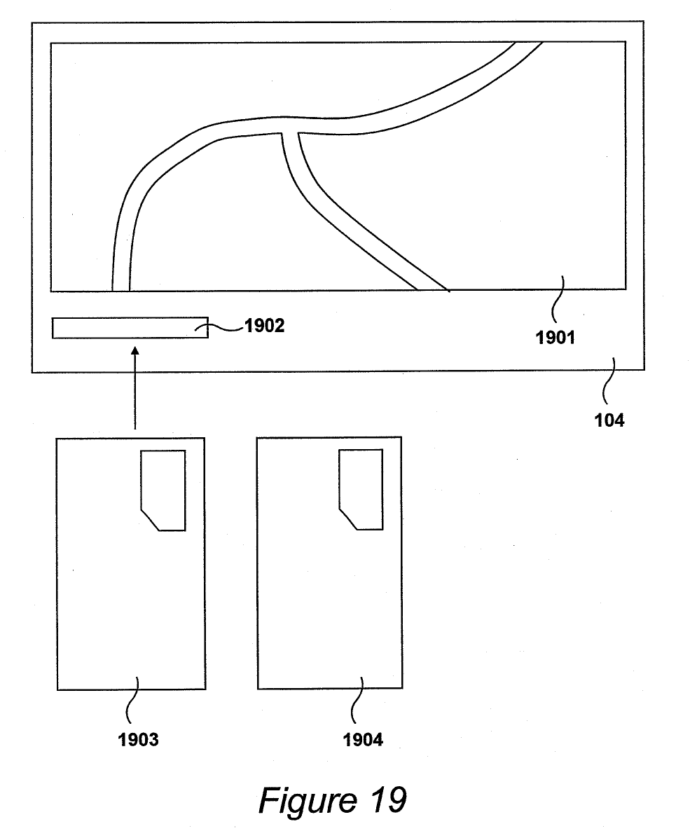

Processor 304 includes memory 309 provided by RAM and flash memory. Cryptographic engine 306 also includes memory 310, similarly provided by RAM and flash memory. In this embodiment, the cryptographic engine is provided by a SIM card. Because SIM cards are used in mobile telephones, the technology is generally trusted by users, and they are considered to be impracticably difficult to hack or forge. However, other cryptographic engines may be used; for example, a chip soldered to the PCB or a “smart card” (an example of this is described with reference to FIG. 19).

Because the cryptographic engine is impractically difficult to compromise, all parties will be able to trust that operations implemented within the cryptographic engine will be performed fairly. Thus, for example, when OBU 103 passes journey costs to PPS 111, PPS 111 will be able to trust that the costs are indeed those generated by LPS 110, rather than costs fabricated by compromised OBU software. Established cryptographic protocols, such as authentication using public-key encryption, allow all parties to confirm the authenticity of the cryptographic engine.

GPS receiver 301 communicates with satellites such as GPS satellites 105 and 106. The GPS satellite network comprises up to thirty-two satellites in a constellation around the earth. Generally, if a GPS receiver can receive information from at least four satellites it is able to pin point its location and time with an extremely high degree of accuracy. If altitude is not required, as may often be the case in a system such as that herein described, information from only three satellites may be sufficient. Accuracy may be improved by several methods, including differential GPS, where additional error-correcting data is sent to the GPS receiver by some other channel. An alternative satellite navigation system to GPS may be used instead.

GSM radio module 305 communicates with base stations of GSM mobile telephone network 108. Again, this technology is well-developed for use with mobile telephones and there are few, if any, parts of the country that are not covered.

Radio transceiver 311 communicates as necessary with road-side radio beacons or cameras as part of a compliance check process.

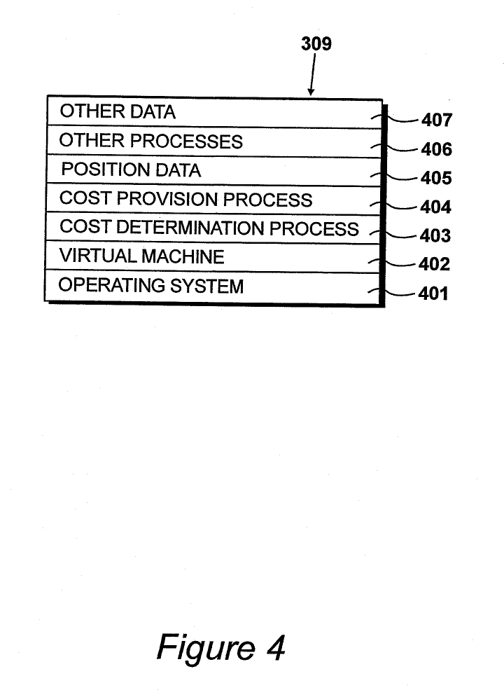

FIG. 4

FIG. 4 illustrates the contents of memory 309 of processor 304. An operating system 401 provides basic functionality for the CPU, and a virtual machine 402 runs two main processes, cost determination process 403 and cost provision process 404. Journey position data 405 are accumulated from GPS data. The memory also includes other processes 406 and other data 407.

Processes running on processor 304 communicate with processes running on cryptographic engine 306 as necessary in order for cryptographic operations to be performed or secure data to be processed.

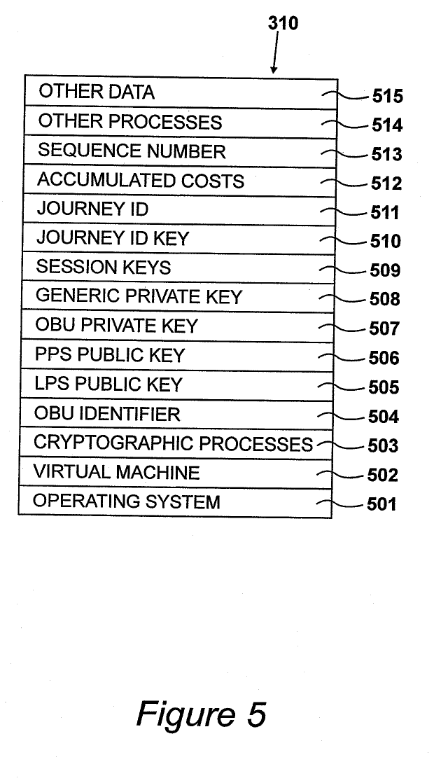

FIG. 5

FIG. 5 illustrates the contents of memory 310 in cryptographic engine 306. Typically, an operating system 501 and a virtual machine 502 execute cryptographic processes 503. Sensitive data is stored securely within the SIM card so that it cannot be accessed or tampered with in order to circumvent the integrity of the protocols. This secure data includes OBU identifier 504, the public key 505 of LPS 110, the public key 506 of PPS 111, the private key 507 of the OBU and the generic private key 508 of the cryptographic engine, all for use in public-key encryption operations. Private keys 507 and 508 each have a paired public key that is publicly available. Memory 310 also contains session keys 509, journey identifier key 510 used to generate journey identifiers, a journey identifier 511, accumulated costs 512 and a sequence number 513 for communicating with PPS 111. The memory also includes other processes 514 and other data 515, which includes random numbers.

The memory includes two private keys. OBU private key 507 is unique to the cryptographic engine and allows it to authenticate itself as a specific unit. However, generic private key 508 is common to all cryptographic engines used in OBUs and allows the cryptographic engine to authenticate itself as being part of an authentic OBU without revealing its identity. This allows anonymous communication links to be set up between OBU 103 and LPS 110. In other embodiments where the cryptographic engine is differently provided a similar private key may be used.

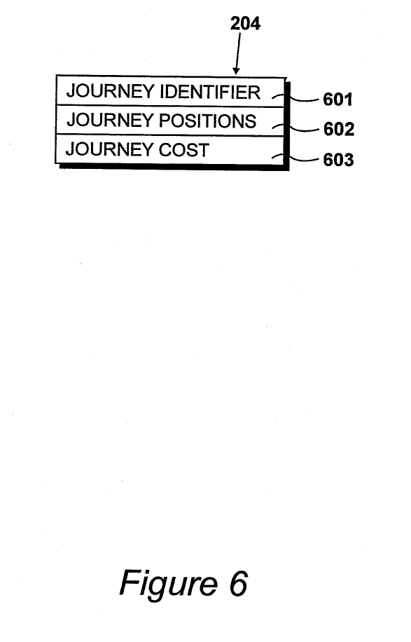

FIG. 6

FIG. 6 details database 204 held on LPS 110 in which journey details 203 and journey costs 205 are stored. Each journey comprises a journey identifier 601, a number of journey positions 602 each comprising a location and time, and a calculated cost 603. LPS 110 stores these details so that at a later date a journey that an OBU claims to have made can be checked in order to ensure integrity of the system, and also so that a user may be provided with an itemised bill if required.

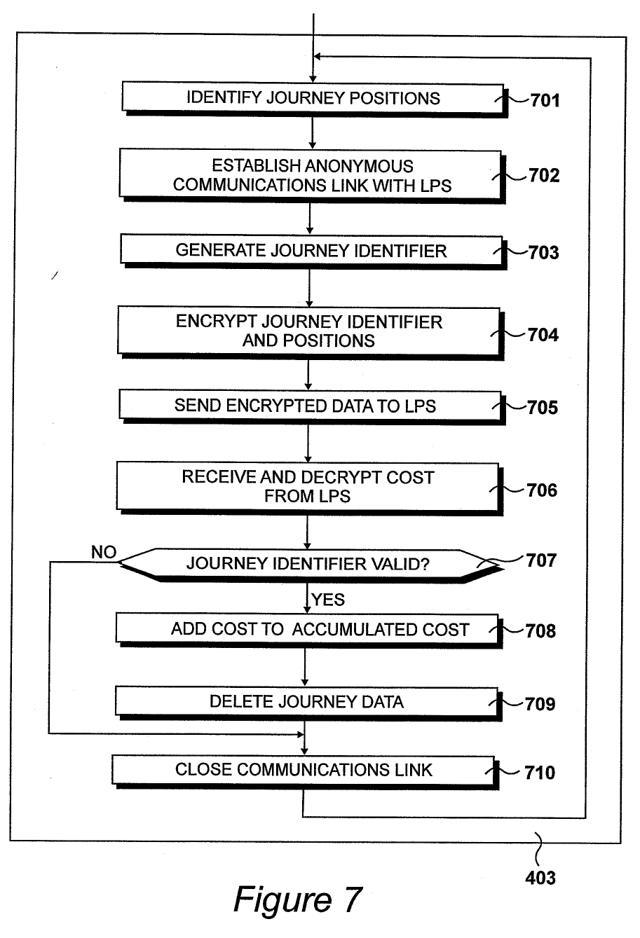

FIG. 7

Cost determination process 403 carried out by processor 304 on OBU 103 determines the cost of a particular journey by sending journey details 203 to LPS 110 and receiving a cost 205 in return. Certain cryptographic operations are performed by the cryptographic engine 306 so that various parties may trust that information being transferred can be trusted.

It is not preferable for this journey to comprise the entirety of an journey made car 101, because even though the details of the journey stored in database 204 are not linked to a user, a third party noting a journey from, for example, a particular person's place of residence to their place of work would easily identify that journey as probably being made by that person. Thus it is preferable for journeys to be broken down into sub-journeys. In order to make entire journeys more difficult to recreate, it is possible to ensure that sub-journeys are started and ended at points such as junctions in the road through which many vehicles may be expected to pass.

Cost determination process 403 is detailed in FIG. 7. At step 701 a plurality of journey positions 602 are identified from position data 405. In this embodiment each position comprises a location in two dimensions only, the altitude not being needed, and a time. Preferably, the positions are sampled from GPS data at a specific sampling rate, and thus the time interval between each position is known. At a minimum, the start and end positions of the journey must be provided, but in order to provide additional integrity for the system and to allow the specific roads used to be identified and the distance traveled to be measured, a plurality of positions are preferable. The accuracy of the time component of each position may be deliberately reduced in order to reduce the chance that sub-journeys can be pieced together.

At step 702 a secure, anonymous connection is established with LPS 110 by OBU 103. The connection is established, both parties authenticate each other, and a session key 509 is established using asymmetric public-key encryption, following the standard Secure Sockets Layer (SSL) method. Alternatively, other authentication and key exchange protocols can be used. Once the session key 509 is established, further communication can be symmetrically encrypted using this key. Symmetric key encryption is less computationally intensive than public-key encryption and so in this embodiment is used where possible. Public-key encryption is used in order to allow the two parties to authenticate each other and to securely establish the session key.

In public-key encryption each party obtains two keys, a public key that is made publicly available and a private key that is kept secret. A message encrypted by a sender using a receiver's public key can only be decrypted using the receiver's private key, and thus can only be decrypted by the receiver. Conversely, a message can be digitally signed by a sender by encrypting it with the sender's private key. The receiver can decrypt the message using the sender's public key, and if this decryption step is successful this verifies that the message did indeed issue from the sender. A message encrypted with a private key is called a digital signature.

Communication between OBU 103 and LPS 110 is anonymous so that journey details cannot be linked with any particular user, and therefore when establishing the communication link GSM modem 302 must appear anonymous. This is done by using an anonymous International Mobile Subscriber Identity (IMSI) number, which is the serial number of a SIM card and which is normally related to a telephone number. In this embodiment an anonymous IMSI number is selected at random from a large pool of numbers. In alternative embodiments other methods could be used to ensure an untraceable GSM communications channel.

Thus the process carried out at step 702 involves opening a GSM communications channel with LPS 110 using an available IMSI number and performing an authentication and key exchange protocol with LPS 110 using generic private key 508, the public key 505 of LPS 110, and random numbers generated by the cryptographic engine. During this process both parties authenticate each other and they agree on session key 509, based on random numbers that they exchange. When the OBU next establishes a communications link with LPS 110 a different IMSI number is used, along with a different session key. Thus LPS 110 is never aware of the identity of the OBU and cannot link any two communications as emanating from the same OBU.

Once communication has been established, at step 703 the cryptographic engine 306 generates a journey identifier 511 using journey identifier key 510. In this embodiment, the journey identifier 511 is generated by a function of the key 510 and time, meaning that in order for the identifiers to be regenerated the time must be a multiple of a standard interval. However, other ways of generating identifiers could be used as long as they can be regenerated at a later date. Journey identifier 511 would appear to be a random number to anyone not possessing journey identifier key 510.

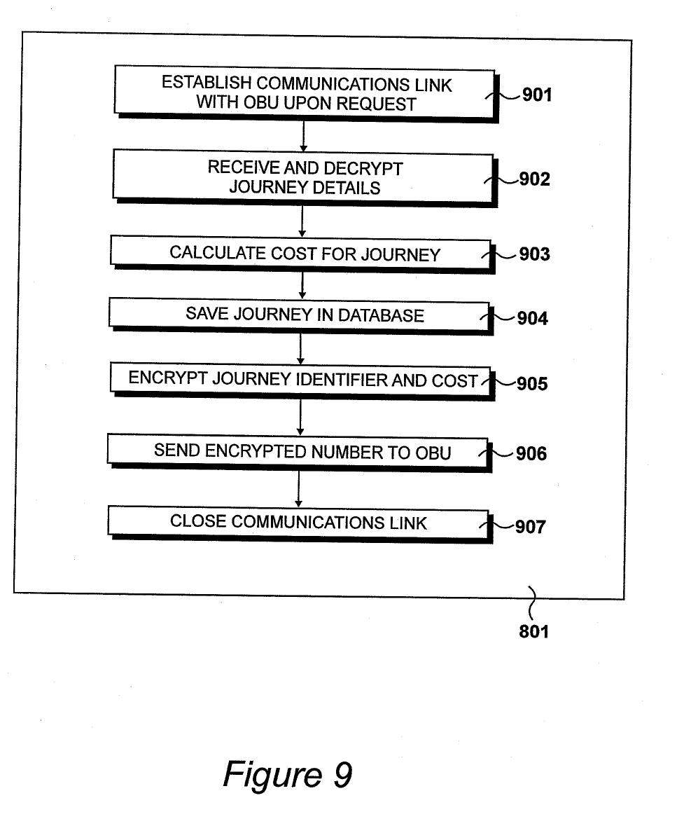

At step 704 the cryptographic engine 306 uses generic private key 508 to create a digital signature of the journey details 203, consisting of the journey identifier 511 and the position data 405. It then encrypts the journey details and the signature using the session key 509. No identification of OBU 103 is included. At step 705 this encrypted data is sent to LPS 110, which processes the data, as will be described further with respect to FIG. 9, and sends an encrypted reply.

At step 706 this reply is decrypted using session key 509 and its digital signature is verified using the LPS's public key 505. The reply should contain a journey identifier 601 and a journey cost 603, and thus at step 707 a question is asked as to whether the received journey identifier 601 correlates with stored journey identifier 511. If this question is answered in the negative or if the decryption or verification is not successful then the communication is for some reason not secure and the communications link is closed at step 710. The OBU will then restart the process.

However, if the question is answered in the affirmative then at step 708 the received journey cost 603 is added to the accumulated costs 512, at step 709 the position data 405 for which the cost has been obtained, the session key 509 and the journey identifier 511 are deleted, and at step 710 the communications link is closed. The process then returns to step 701 to identify another journey.

Thus at the completion of every cycle of process 403 a cost 603 for a journey has been anonymously obtained and added to accumulated costs 512. Preferably, journey identifiers are not permanently stored on OBU 103 so that a third party in possession of OBU 103 cannot obtain journey details and thus compromise the user's privacy.

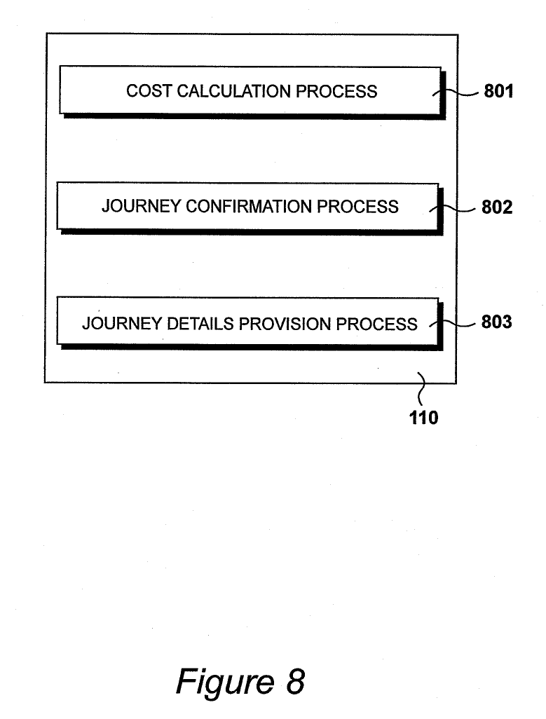

FIG. 8

The three main processes carried out by LPS 110 are illustrated in FIG. 8. During cost calculation process 801, the LPS receives journey details from an OBU and returns a cost.

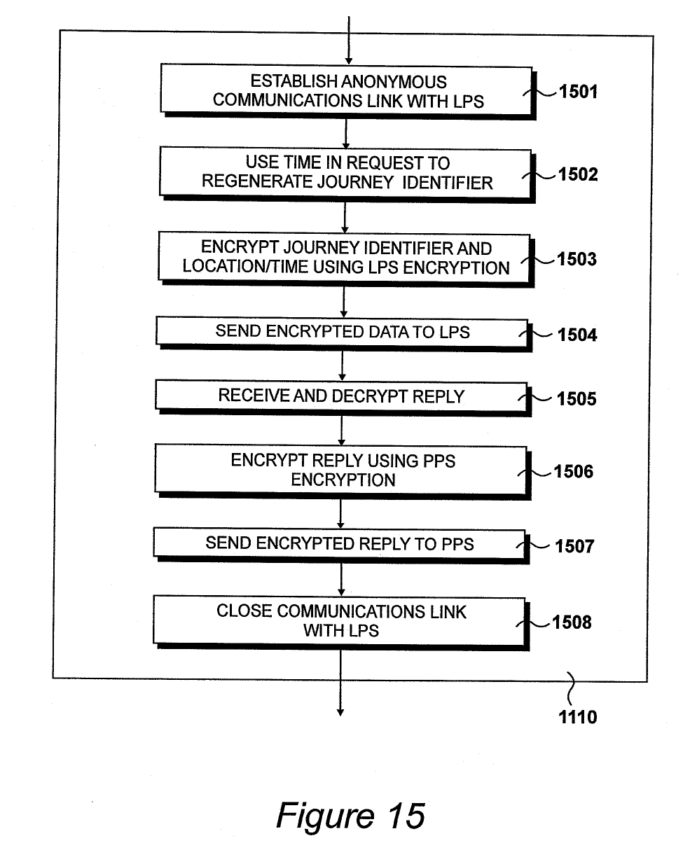

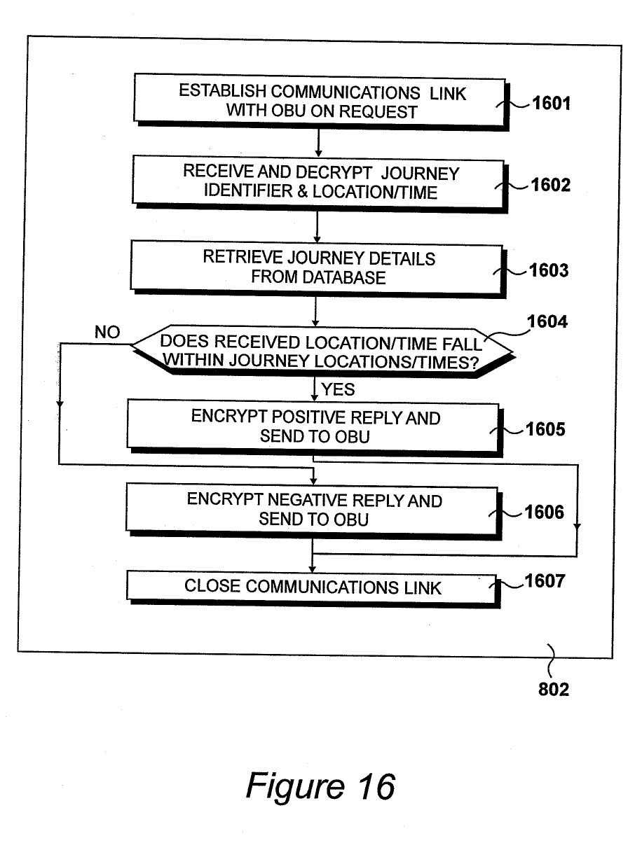

When carrying out journey confirmation process 802 the LPS receives a particular position and a journey identifier and indicates whether or is not that position is contained within the identified journey. This will be discussed further with reference to FIGS. 15 and 16.

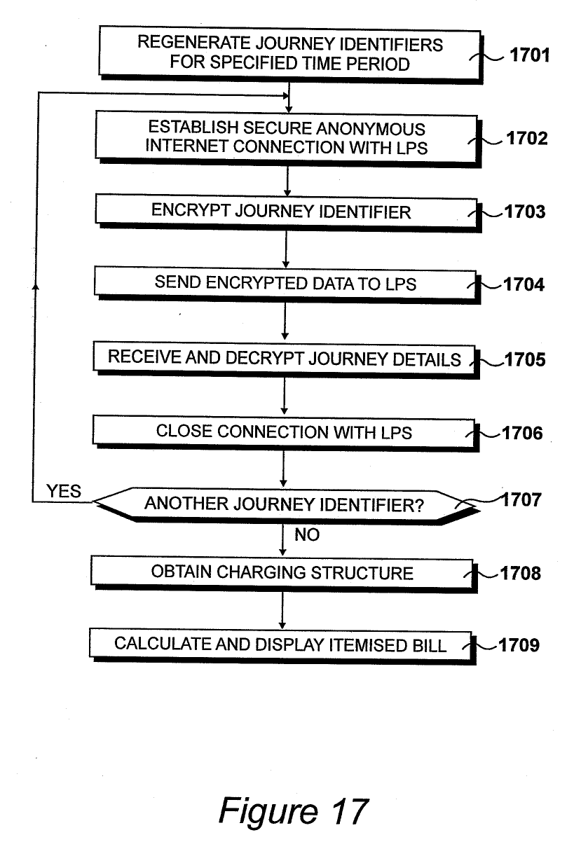

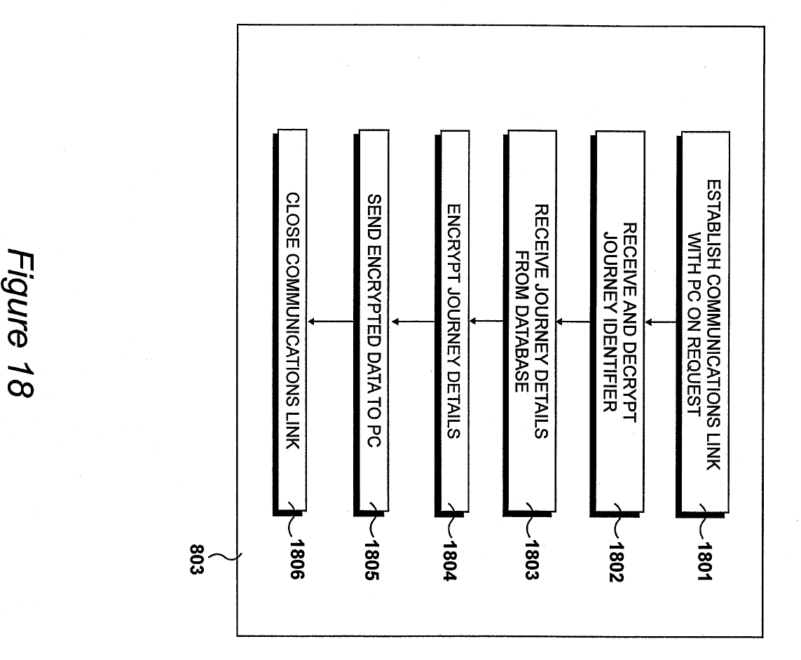

When carrying out journey details provision process 803, the LPS receives a number of journey identifiers and provides all the journey details and costs associated with those identifiers. This is done only when a user requests an itemised bill, as will be discussed further with respect to FIGS. 17 and 18.

FIG. 9

FIG. 9 details cost calculation process 801 that runs on LPS 110. At step 901, in response to the request sent at step 702 by OBU 103, the LPS 110 establishes a communications link with the OBU, as described with reference to FIG. 7. At step 902 the journey details sent by OBU 103 at step 705 are received and decrypted using session key 509 and the digital signature is verified using the public key paired with generic private key 508.

At step 903 a cost is calculated for this journey. As discussed previously, the cost can be calculated in any way that takes into account the times and locations of the provided position data, such as distance traveled, absolute location, time of day, speed, and so on. In addition, OBU 103 may also send with the journey details additional position-related data from any of its sensors 308. LPS 110 can use this information to verify that the position data appears plausible. For example, if the position data indicated a night journey but the light sensor indicated bright light, this might flag possible spoofed position data. Other examples of additional position-related data that could be sent are local weather conditions, altitude, altitude differences along a portion of the journey, distance data from the odometer and data broadcast by local radio transmitters.

At step 904 the journey details and journey cost 603 are saved in database 204 and at step 905 the journey identifier 601 and the cost 603 are digitally signed with the private key of LPS 110 (paired with public key 505) and encrypted with session key 509 before being sent to the OBU at step 906. At step 907 the communications link is closed.

Preferably, the LPS is set up so that multiple instances of this process can run at any one time, since the LPS will typically be servicing a very large number of OBUs. In a large system, it may be practical to have a plurality of location processing services, any one of which may be used by any OBU. Further, the journey details sent by OBU 103 may indicate the type of cost that is required. In this way, a small company or association may use the system described herein without having to set up its own location processing services by piggy-backing on existing ones.

In an alternative embodiment, OBU 103 calculates its own costs. This eliminates the need for the LPS but means that journey details are stored on the OBU rather than in an anonymous database. Alternatively, once the OBU has calculated its costs it can send the journey details to the LPS for storage. In a further embodiment, cost calculation could be shared between the OBU and LPS.

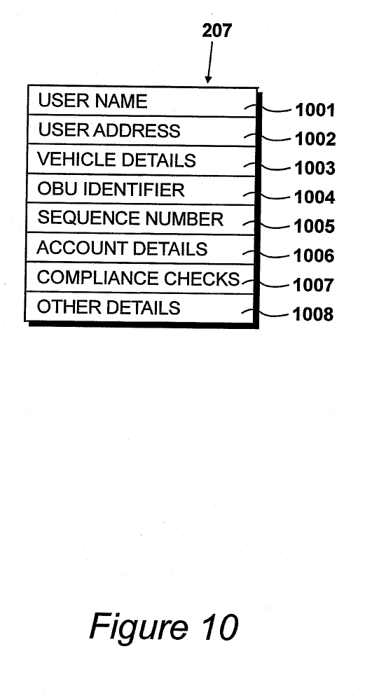

FIG. 10

Once the OBU 103 has received a cost for a journey from the LPS 110, it must transmit this cost to PPS 111 in order to pay for it. In contrast with LPS 110, PPS 111 knows the identity of all the OBUs and their associated users. FIG. 10 illustrates database 207 held on PPS 111 which stores all this data.

Database 207 therefore includes a user name 1001, a user address 1002, vehicle details 1003, including for example the registration number, make model and engine size, the OBU identifier 1004 associated with that user, and a sequence number 1005 that identifies individual communication sessions between the OBU and the PPS. Account details 1006 indicate payment amounts and methods. Payment could be made by a user in arrears or in advance.

Compliance checks 1007 are also stored in the database. These indicate times and locations at which the vehicle was seen and which need to be verified with the OBU. Thus in this embodiment PPS 111 performs the task of a validation server. In an alternative embodiment the validation server might be separate or the compliance check might be carried out in another way, and thus this data might be stored elsewhere.

Other details 1008 would vary widely according to the purpose of the system. Details could include, for example, insurance details, the number of hours a day a truck driver is permitted to drive, places in which the user is permitted to park, other details of the user, for example their age, other users who are permitted to drive the vehicle, and so on.

If the system were to be used for payment of public transport costs, for example, then clearly there would be no vehicle details. The exact nature of database 207 is therefore variable and dependent on the purpose of the system. Further, PPS 111 could in fact be part of a number of different systems, and hold different databases possibly comprising the same users but for different purposes. Thus, for example, upon receiving a journey cost it might generate a charge for road tax and also calculate whether an insurance premium should be increased.

Again, many Payment Processing Systems may be included in a single system, depending upon how many users there are in the system and the capabilities of the service. Preferably, if there are multiple Location Processing Systems and Payment Processing Systems they occur in pairs, but this is not necessary.

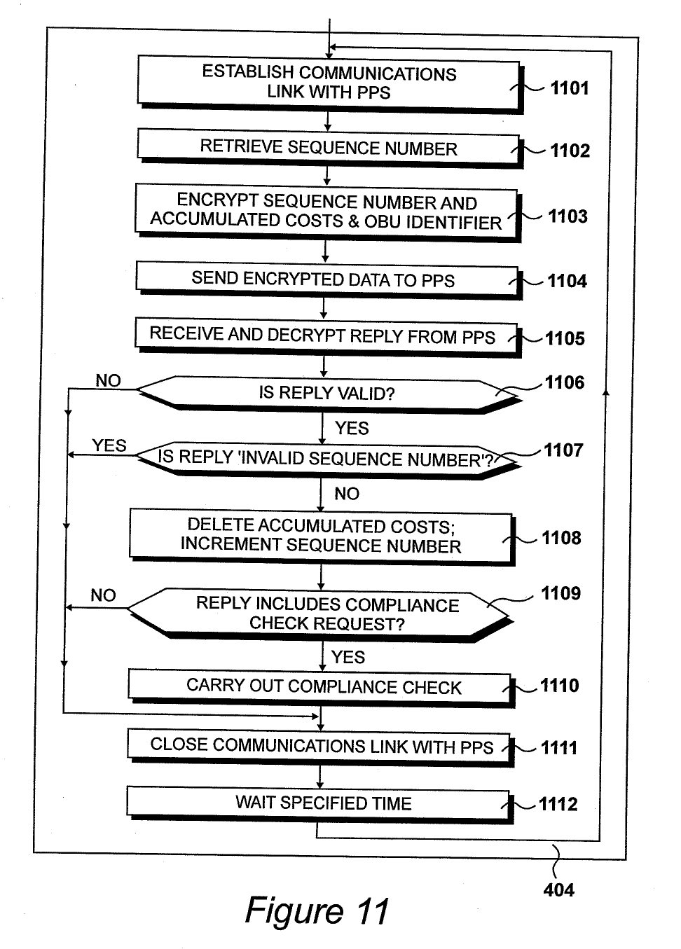

FIG. 11

FIG. 11 details cost provision process 404 which runs on on-board unit 103. This process periodically sends accumulated costs 512 to PPS 111. Thus at step 1101 a communications link is established with PPS 111. This is done in the same way as establishing a communications link with LPS 110 at step 702, except that in this case the communication is not anonymous. Therefore it is not necessary to obtain an anonymous IMSI number, although neither is it necessary to use the same one each time. Also, the authentication process is done using OBU private key 507 and the corresponding public key.

At step 1102 the next sequence number 513 is retrieved and at step 1103 data including this sequence number, the accumulated costs 512 and the OBU identifier 504 are digitally signed using OBU private key 507 and encrypted using the session key established during step 1101. This data is then sent to PPS 111 at step 1104.

At step 1105 a reply is received from PPS 111, it is decrypted using the session key, and its signature is verified using the known public key 506 of PPS 111. At 1106 a question is asked as to whether the reply is valid. This includes checking that the decryption is successful, that the signature is validated and that it includes the same sequence number as that sent. If this question is answered in the negative then the communications link is closed at step 1111. If the question is answered in the affirmative then at step 1107 a further question is asked as to whether the reply is that the sent sequence number was invalid. If this question is answered in the affirmative then again the communications link is closed at step 1111.

However, if this question is answered in the negative then the costs have been successfully received and charged by the PPS 111. Thus at step 1108 the accumulated costs 512 are reset to zero, and the sequence number 513 is incremented by 1.

At 1109 a question is asked as to whether the reply included a compliance check request, and if this question is answered in the affirmative then the compliance check is carried out at step 1110, as will be described further with respect to FIG. 15.

At step 1111 the communications link with the PPS is closed and at step 1112 the process waits a specified time before carrying out the process again. In other embodiments, the process may be initiated whenever the accumulated costs exceeds a certain level, but it is preferable for it to happen at regular intervals, even if the accumulated costs are zero, because PPS 111 may have outstanding compliance checks that it needs to forward to the OBU.

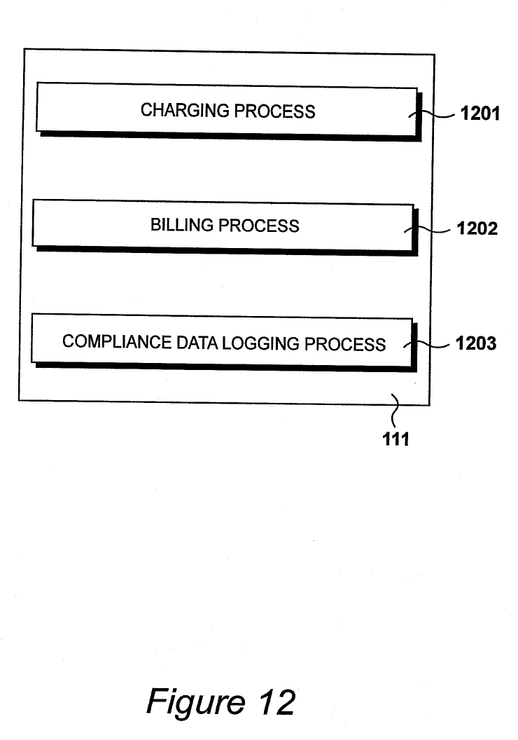

FIG. 12

PPS 111 carries out three main functions. Charging process 1201 receives costs from on-board unit and converts them into charges, applying these to users' accounts.

Optionally, billing process 1202 (not detailed further) may run regularly in order to generate paper or electronic bills to users. Alternatively, or additionally, the system may provide an online service whereby a user can check his bill without requiring the involvement of the PPS. This may be particularly useful for prepayment services where no bills are necessary, and will be discussed further with reference to FIGS. 17 and 18.

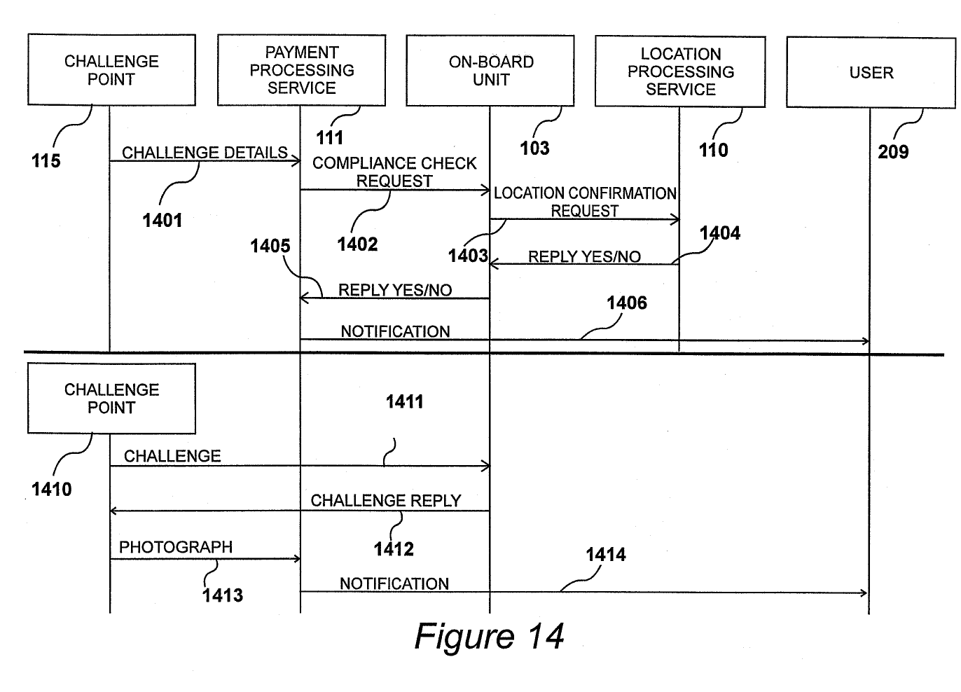

Compliance data logging process 1203 (not detailed further) receives information from challenge points such as roadside cameras that a vehicle was seen in a particular place and a particular time, and adds these to the user's account in order to carry out a compliance check at some point when the OBU is next in communication; in this embodiment this is at step 1309 of process 1202, as described with reference to FIG. 14.

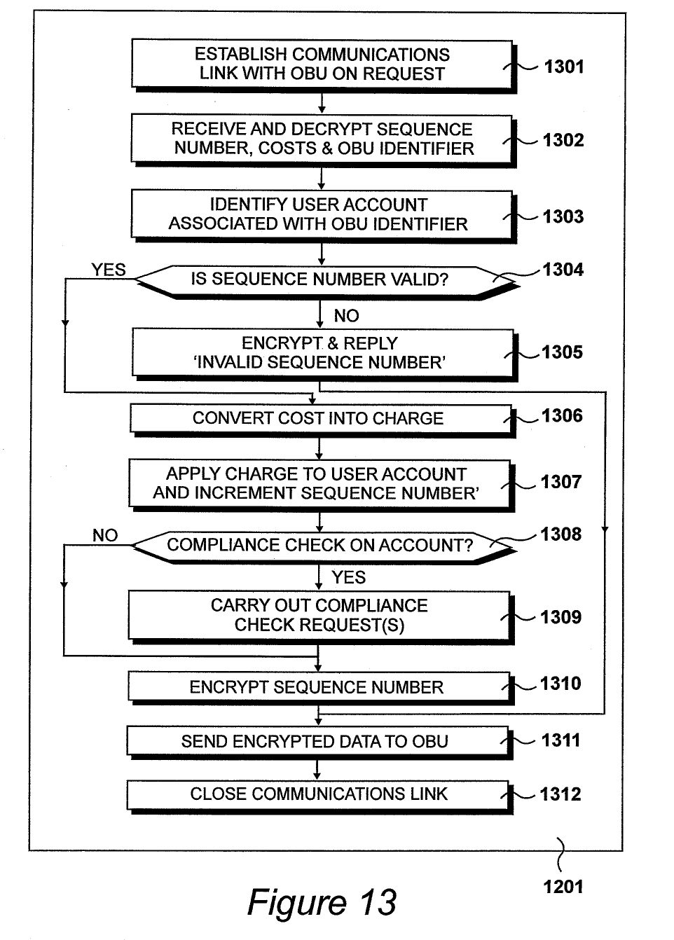

FIG. 13

FIG. 13 details charging process 1201 on PPS 111. At step 1301 a communications link is established with an OBU upon receipt of the request sent at step 1101. This is done in the same way as the LPS 110 establishes communication at step 901, except that the link is not anonymous and the public key paired with OBU private key 507 is used. At step 1302 the data sent by the OBU at step 1104 is received and decrypted using the session key 509 established during step 1301, and the digital signature is verified using the OBU's public key. This data comprises the OBU identifier, a sequence number and an accumulated cost.

At step 1303 the user account in database 207 associated with the OBU identifier is identified and at step 1304 a question is asked as to whether the received sequence number is the same as the expected sequence number 1005. If this question is answered in the negative then the reply “invalid sequence number” is digitally signed, encrypted and returned to the OBU at step 1305. However, if the question is answered in the affirmative then at step 1306 the cost is converted into a charge of some form, which as previously described may be monetary or otherwise, and at step 1307 this charge is applied to the user account and the sequence number 1005 is incremented by 1.

At step 1308 a question is asked as to whether there is a compliance check 1007 on the account and if this question is answered in the affirmative then a compliance check request is sent at step 1309, as will be discussed further with reference to FIG. 14.

At step 1310 the sequence number is digitally signed using the private key of PPS 111 (paired with public key 506) and encrypted using the session key, and at step 1311 it is sent to the OBU as an acknowledgement that the charge has been applied to the account. At step 1312 the communications link is closed.

FIG. 14

As previously discussed, in order to ensure the privacy of users of the system described herein there is no way for a third party to connect any journey details held by LPS 110 with any of the user details held by PPS 111. The only information linking journey details with users' identities is contained within the OBUs. However, to ensure the integrity of the system regular checks must be made in case users have tampered with or disconnected their OBUs, or OBUs malfunction. Since all communication between OBU 103 and LPS 110 or PPS 111 is carried out using established cryptographic methods on an established cryptographic engine, certain assumptions can be made about the resilience of the system against attacks. These are that the cryptographic engine cannot be hacked, that information digitally signed by an OBU did in fact originate from that OBU, and that data stored within the cryptographic engine cannot be altered or revealed except by the program running on the cryptographic engine.

However, there are many ways in which a user may attempt to subvert the system. These include, for example, spoofing the GPS data by hacking GPS receiver 301, removing the OBU entirely and leaving it behind while driving around, and attempting to alter communication to and from the cryptographic engine. This last can always be detected because the digital signing and encryption of the data means that any tampering with the data will be obvious. However the first two need to be protected against.

It would be virtually impossible to create an OBU which was not removable from a vehicle, not openable and not hackable (except for the cryptographic engine). Also, it is preferable that an OBU be as accessible as possible in order for users to trust the system.

Thus, compliance checks are used. Two ways of doing this are suggested in FIG. 14. Both involve use of a challenge point, which in the first method is provided by roadside camera 115. When a vehicle passes camera 115 a picture is taken of the registration number of the vehicle. Camera 115 includes an automatic registration number recognition system and at 1401 it passes the location, date and registration number of the vehicle via central compliance system 117 to PPS 111, which logs the sighting of the vehicle in user database 207. Upon the OBU associated with that vehicle next establishing contact with PPS 111, the location and time are sent to the OBU as a compliance check request 1402. Details of where that OBU has been are held in database 204 under an anonymous journey identifier. In this embodiment, the journey identifier is a function of time and thus the OBU simply regenerates the journey identifier and sends a location confirmation request 1403 to LPS 110, containing the journey identifier and the location and time from compliance check request 1402. LPS 110 checks whether the identified journey contains the specified location and time and returns a reply 1404 of yes or no to the OBU, which forwards this reply 1405 to the PPS. Since the reply is digitally signed first by LPS 110 and then by the cryptographic engine on the OBU, PPS 111 can trust it. If the reply is that the specified journey did not contain the particular location this indicates that the OBU is malfunctioning in some way and thus a notification 1406 is sent to the user 209 and a process of checking or replacing the OBU is started.

The steps carried out by OBU 103 and LPS 110 to perform this compliance check are detailed in FIGS. 15 and 16.

An alternative, or additional, check does not involve LPS 110 and is shown in the second method. In this, a challenge point is provided by roadside beacon 1410, which is configured to communicate with radio transceiver 311 and includes a camera. On detecting an OBU, the beacon 1410 would issue a challenge 1411 to the OBU, asking the cryptographic engine to confirm that it is part of a valid on-board unit, that it is operating normally, and that it thinks that it is in the same location as the beacon. The cryptographic engine replies at 1412 and if the answer is negative the challenge point 115 takes a photograph 1413 of the vehicle and sends it to PPS 111. PPS 111 then identifies the registration number and issues a notification 1414 to the user 209. If the challenge point 1400 detected a vehicle but could not detect an OBU, it would also take a photograph. This method would reduce the systematic capture of vehicle identities by camera, since only a faulty OBU would trigger a photograph, which the public might be happier with.

Although in the embodiments described herein cameras 115 and 116 and beacon 1400 are implemented as fixed challenge points, they could also be mobile challenge points, mounted in police cars or vehicles that are frequently on the road such as buses. Further, each OBU could itself be a challenge point and OBUs could interrogate each other as they pass.

FIG. 15

FIG. 15 details step 1110, at which OBU 103 carries out a compliance check having received position data including a location and a time from PPS 111. On behalf of PPS 111, OBU 103 asks LPS 110 whether or not OBU 103 has obtained a cost for a journey that included the indicated location at the indicated time, and passes the reply from LPS 110 back to PPS 111.

Thus at step 1501 OBU 103 establishes an anonymous communications link with LPS 110 in the same way as at step 702. At step 1502 the time in the position data and journey identifier key 510 are used to regenerate a journey identifier.

At step 1503 the journey identifier and position data are digitally signed using generic private key 508 and encrypted using the session key established during step 1501, and at step 1504 this data is sent to LPS 110. At step 1505 a reply is received and decrypted, and the digital signature is verified using the public key 505 of LPS 110. The reply will be an affirmative reply if the journey identifier referenced a journey containing the indicated location and time, and negative otherwise.

At step 1506 the reply is digitally signed using private key 507 and encrypted using the session key established at step 1101 before being sent to PPS 111 at step 1507. At step 1508 the communications link with LPS 110 is closed.

When PPS 111 receives this reply it can trust that it is accurate since cryptographic engine 306 is considered trustworthy. However, no journey details are passed to PPS 111 and no more information is available to it than was originally known from the challenge point's data.

FIG. 16

FIG. 16 details journey confirmation process 802 that runs on LPS 110. At step 1601 a communications link is established with a requesting OBU on receipt of the request sent at step 1501. This is done in the same way as at step 901. At step 1602 a message is received from OBU 103 and decrypted using the session key established at step 1601, and the digital signature is verified using the public key paired with generic private key 508.

At step 1603 the journey details associated with the received journey identifier are retrieved from database 204 and at step 1604 a question is asked as to whether the time and location received in the message correspond with any of the position data 602 contained within that journey. A certain level of tolerance may be required to account for the slightly different locations of the OBU and the challenge point, and possible slight errors in the GPS data. If the question asked at step 1604 is answered in the affirmative then at step 1605 a positive reply is digitally signed, encrypted and returned to the OBU. If the question is answered in the negative then at step 1606 a negative reply is digitally signed and encrypted, and sent to the OBU. At step 1607 the communications link is closed.

Thus it is checked whether an OBU that has been seen at a particular location and time has obtained a cost for a journey that included that location and time. Provided this check receives a positive reply and is carried out frequently, preferably whenever the vehicle is seen by a camera, it can be assumed that the OBU is functioning normally. In order to ensure that the system works, the locations of the challenge points could be kept secret, or alternatively a mixture of fixed and mobile challenge points could be used.

FIG. 17

In a system such as that described herein it is likely that any user would want to be able to check whether his bill is correct, or challenge something he feels is incorrect. For example, he may feel that his road tax bill is too high, he may think he has been charged an extra premium on his insurance that was not necessary, he may think that he has been charged for car parking when he has not parked anywhere recently, or he may simply have a certain level of distrust of the system.

If a user wishes to keep his journey details absolutely private it is best that he do not have an itemised bill. Alternatively, should he have no worry about the journey details being revealed to the system operators, he can reveal all his journey identifiers to PPS 111 which can then receive all his journey details from LPS 110 and provide a regular itemised bill. However, neither of these options is preferable. FIG. 17 details a method in which the user can retrieve his own journey details without divulging them to PPS 111. In this embodiment, the user does this via his personal computer 113 as shown in FIG. 17.

The details of a users journeys are stored in database 204 held on LPS 110, indexed by a series of journey identifiers 601. In order to retrieve journey details the user needs these journey identifiers. These can be regenerated on the user's personal computer 113 using journey identifier key 510. Thus it is necessary for personal computer 113 and OBU 103 to share the same journey identifier key 510.

In this embodiment, a journey identifier key is created from time to time by a random number generator running on personal computer 113, and is stored locally on personal computer 113. Personal computer 113 encrypts it with the public key paried with OBU private key 507 and sent to OBU 103 via Internet 109, PPS 111 and GSM network 108, in a process in which personal computer 113 and the cryptographic engine on OBU 103 authenticate each other. However, any method that allows personal computer 113 to obtain or create journey identifier key 510 may be used.

Thus at step 1701 the process is started with the regeneration of journey identifiers for a particular time period. In this embodiment, journey identifiers are based on specific intervals of time and thus the regeneration uses journey identifier key 510 and times and dates for which the itemised bill is required.

At step 1702 a secure, anonymous Internet connection is established with LPS 110. This is done using hypertext transfer protocol over SSL (https), but any secure method could be used. At step 1703 a journey identifier is encrypted, and at step 1704 it is sent to LPS 110. At step 1705 the reply is decrypted and the journey details contained within it are extracted. The connection with LPS 110 is then closed at step 1706.

At step 1707 a question is asked as to whether there is another journey identifier for which journey details should be retrieved, and if this question is answered in the affirmative control is returned to step 1702. Alternatively, all the journey details have been retrieved and the question is answered in the negative.

At step 1708 a charging structure is retrieved, either from local storage, from the Internet or from some other location. This is the structure that PPS 111 uses to convert costs into charges, and should be publicly available to ensure public trust of the system. Thus at step 1709 the process can calculate and display an itemised bill to the user.

In order to ensure maximum security for the user, it is preferable that the journey identifiers be submitted to the LPS individually and non-chronologically. If they were submitted in the same connection then even though the communications links is anonymous this would allow the LPS, if its designer so wished, to note that certain journeys belonged to the same user. This might allow the user to be identified. Also, all the journey details should not be sent in the same communication but should be split up and routed differently over the Internet. Privacy-enhancing Internet techniques such as “onion routers” can be used to provide a greater level of anonymity for the user by routing messages through the Internet using different routes that are difficult to trace.

FIG. 18

FIG. 18 describes journey details provision process 803 carried out on LPS 110. At step 1801 a communications link is established with a personal computer on receipt of a request sent at step 1701. At step 1802 a communication including a journey identifier is received and decrypted. At step 1803 the journey details, including costs, are retrieved from database 204 and at step 1804 these details are encrypted. The data is then sent to the PC at step 1805 and at step 1806 the communications link is closed.

As an alternative to this method of providing an itemised bill it is possible that the OBU could, whenever it submits journey details to LPS 110 to obtain a cost, also submit them to a third party location or to the user's personal computer. However, this would involve storage of all the journey details in another location, which would undermine the inherent security of the system.

FIG. 19

FIG. 19 illustrates an alternative embodiment of an on-board unit. OBU 104 is embodied as an in car satellite navigation system. It includes a display 1901 and a slot 1902 for receipt of a smart card, such as is used in satellite television systems. Many drivers already use satellite navigation systems and these already include many of the components necessary for an OBU, such as a processor and a GPS receiver. Smart card 1903 or smart card 1904, when inserted into the slot 1902, would provide the cryptographic engine for OBU 104. Thus in this embodiment, several users of the same vehicle could insert their own smart card whenever using it, ensuring that they get separately billed. This might be of particular use for company cars, hire cars and cars shared by many family members. It would also add an additional level of security in that removal of the smart card would render OBU 104 non-functional, meaning that if the vehicle were stolen it would fail the first compliance check that it encountered, which could flag its location.

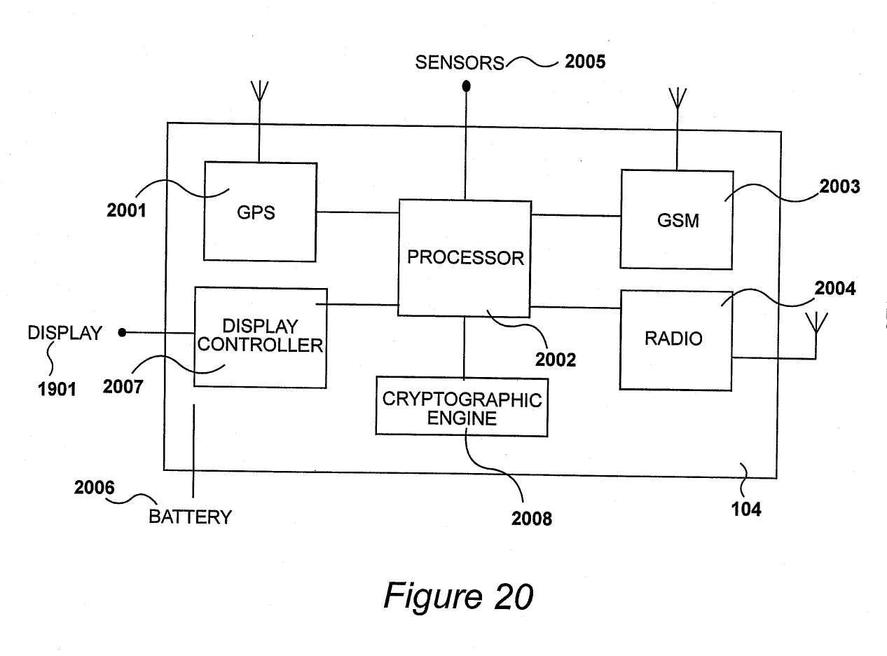

FIG. 20

A diagram of OBU 104 is shown in FIG. 20. Similarly to OBU 103, it includes a GPS receiver 2001, a processor 2002, a GSM radio module 2003, and a radio transceiver 2004. It has input from sensors 2005 and takes power from battery 2006. It also includes a display controller 2007 that outputs to display 1901.

However in OBU 104 the cryptographic engine 2008 is provided by smart card 1903 or 1904. Without this, it can still function as a satellite navigation system but not as an on-board unit. In an alternative embodiment, the OBU could include a SIM card that provides a cryptographic engine only if a smart card were not present.

In a further alternative embodiment, the functionality of an on-board unit could be partially or entirely provided by a mobile telephone. An on-board unit could communicate either wirelessly or by a wired connection with the telephone whose SIM card would be the cryptographic engine. The telephone could also provide the GSM radio module, the global navigation satellite system receiver and even the processor.

1. A method of position-based charging, comprising the steps of:
identifying journey details including a plurality of position data, each representing a location of a position-sensing device during a journey;
determining a cost for said journey; and
forwarding said cost and an identification of said position-sensing device from said position-sensing device to a payment processing service.

2. A method according to claim 1, wherein said position-sensing device comprises a cryptographic engine.

3. A method according to claim 1, wherein said position-sensing device comprises a navigation device.

4. A method according to claim 1, wherein each of said position data includes a date and time.

5. A method according to claim 1, wherein said journey is a portion of a longer journey.

6. A method according to claim 1, wherein said journey details further comprise a unique journey identifier.

7. A method according to claim 1, wherein said step of determining a cost for said journey comprises the steps of:
establishing a communication link between said position-sensing device and a location processing service;
sending said journey details from said position-sensing device to said location processing service;
at said location processing service, receiving said journey details and calculating a cost for said journey; and
returning said cost from said location processing service to said position-sensing device.

8. A method according to claim 7, wherein said location processing service stores said journey details and costs, and further including the step of producing an itemised bill, comprising the steps of:
obtaining a plurality of journey identifiers; and
retrieving journey details and costs corresponding to each of said journey identifiers from said location processing service.

9. A method according to claim 1, further including the steps of, at said payment processing service:
identifying a user based on said identification of said position-sensing device;
converting said cost into a monetary charge; and
associating said charge with said identified user.

10. A method according to claim 2, wherein said position-sensing device is attached to a road-using vehicle having a registration number, and further including the steps of, at a challenge point:
establishing a communication link with said position-sensing device;
determining whether said position-sensing device is functioning correctly; and
upon determining that said position-sensing device is not functioning correctly, obtaining said registration number of said vehicle.

11. A method according to claim 10, wherein said step of determining whether said position-sensing device is functioning correctly comprises the steps of:
requesting the cryptographic engine to indicate whether it is part of a valid position-sensing device, whether it is operating normally, and whether the position-sensing device is at substantially the location of the challenge point.

12. A position-sensing device comprising position-sensing means, communication means, a processor and memory, wherein said processor is configured to:
identify journey details comprising a plurality of position data identified by said position-sensing means, each representing a location of said position-sensing device during a journey;
determine a cost for said journey; and
forward said cost and an identification of said position-sensing device to a payment processing service via said communication means.

13. A position-sensing device according to claim 12, further comprising a cryptographic engine.

14. A position-sensing device according to claim 13, wherein said cryptographic engine is provided by a SIM card.

15. A position-sensing device according to claim 13, wherein said cryptographic engine is provided by a smart card.

16. A position-sensing device according to claim 12, further comprising a navigation device.

17. A position-sensing device according to claim 16, wherein said navigation device is a global navigation satellite system receiver.

18. A position-sensing device according to claim 12, wherein said processor is configured to accumulate a plurality of journeys before determining costs for them.

19. A position-sensing device according to claim 18, wherein said processor is configured to determine costs for said journeys in a non-chronological order.

20. A position-sensing device according to claim 12, wherein said processor is configured to determine a cost for said journey by:
establishing a communication link between said position-sensing device and a location processing service;
sending said journey details from said position-sensing device to said location processing service; and
receiving a cost for said journey from said location processing device.

21. A position-sensing device according to claim 12, wherein said processor is configured to accumulate a plurality of costs before forwarding said accumulated costs to said payment processing service.

22. A position-sensing device according to claim 12, wherein said processor is further configured to:
receive a request to confirm that it was at a specified location at a specified date and time;
obtain the journey identifier corresponding to the specified date and time; and
confirm that the specified location is contained within said journey.

23. A position-sensing device according to claim 22 wherein said processor is further configured to:
establish a communication link with a location processing service;
send said journey identifier, said indicated location and said indicated date and time to said location processing service; and
receive a confirmation from said location processing service.

24. A position-sensing device according to claim 12, wherein said position-sensing device comprises an in-car satellite navigation system.

25. A position-sensing device according to claim 12, wherein said position-sensing device comprises a global navigation satellite system enabled mobile telephone.

26. A position-sensing device according to claim 12, wherein said position-sensing device comprises a global navigation satellite system receiver and a mobile telephone.
